(19) United States
(12) Patent Application Publication
(10) Pub. No.: US 2023/0316578 A1
(43) Pub. Date: Oct. 5, 2023

(54) MULTICOLOR LOSSLESS IMAGE COMPRESSION

(71) Applicant: GOOGLE LLC, Mountain View, CA (US)

(72) Inventors: Maryla Isuka Waclawa Ustarroz-Calonge, Paris (FR); Vincent Rabaud, Paris (FR)

(21) Appl. No.: 18/001,694

(22) PCT Filed: Sep. 30, 2020
(86) PCT No.: PCT/US2020/053640

§ 371 Date: Dec. 13, 2022

(51) Int. Cl. G06T 9/00

(52) U.S. Cl. CPC G06T 9/00

(57) ABSTRACT

A method including receiving an image targeted for compression into a compressed image, identifying a coding line including a plurality of elements, each of the plurality of elements having a color, selecting an element from the plurality of elements from the coding line in the image, determining a presented color associated with the selected element, comparing the presented color to an expected color, and in response to determining the presented color is not the expected color inserting a marker into a data structure representing a portion of the compressed image, the marker indicating that the presented color is not the expected color, determining an encoding value corresponding to the presented color, and inserting the encoding value into the data structure representing the compressed image.

### FIELD

Embodiments relate to compressing and decompressing images.

### BACKGROUND

Group 4 compression is a lossless compression algorithm used on some types of images. For example, Group 4 compression can be used on images with long runs of pixels of the same black or white color, and where pixels in a row of pixels closely resembles the row above. Group 4 compression works effectively on black and white colors.

### SUMMARY

In a general aspect, a device, a system, a non-transitory computer-readable medium (having stored thereon computer executable program code which can be executed on a computer system), and/or a method can perform a process with a method including receiving an image targeted for compression into a compressed image, identifying a coding line including a plurality of elements, each of the plurality of elements having a color, selecting an element from the plurality of elements from the coding line in the image, determining a presented color associated with the selected element, comparing the presented color to an expected color, and in response to determining the presented color is not the expected color inserting a marker into a data structure representing a portion of the compressed image, the marker indicating that the presented color is not the expected color, determining an encoding value corresponding to the presented color, and inserting the encoding value into the data structure representing the compressed image.

Implementations can include one or more of the following features. For example, the marker can be a Boolean. The coding line can be at least a portion of a row of the image. The selected element can represent a pixel of at least three (3) colors. Determining the encoding value corresponding to the presented color can include looking-up the presented color in a color palette and setting the encoding value as an index value of the color palette that is associated with the presented color. Determining the encoding value corresponding to the presented color can include determining the presented color is not in a color palette, inserting the presented color into the color palette, generating an index value for the inserted presented color, and setting the encoding value as the generated index value. Determining the encoding value corresponding to the presented color can include identifying a row in the image as a reference line, the reference line including a plurality of encoded elements, determining that one of the plurality of encoded elements in the reference line includes the expected color, and in response to determining that one of the plurality of encoded elements in the reference line includes the expected color, setting the encoding value based on one of the plurality of encoded elements.

Setting the encoding value based on one of the plurality of encoded elements can include identifying the encoding value of one of the plurality of encoded elements, and setting the encoding value as the encoding value of one of the plurality of encoded elements. Setting the encoding value based on the determined element can include identifying a position of one of the plurality of encoded elements in the reference line and setting the encoding value based on the identified position. Setting the encoding value based on the identified position can include setting the encoding value as a relative value based on a position of the selected element in the coding line and the position of the identified element in the reference line. The method can further include selecting another element from the plurality of elements from the coding line in the image, determining whether the selected another element is the last element in the encoding line and in response to determining the selected another element is the last element in the encoding line, not inserting at least one of the marker and the encoding value into the data structure representing a portion of the compressed image.

In a general aspect, a device, a system, a non-transitory computer-readable medium (having stored thereon computer executable program code which can be executed on a computer system), and/or a method can perform a process with a method including receiving a data structure representing an image to be decompressed, the image including a plurality of color elements, selecting an element to be decoded from a decoding line in the image, identifying an element in the data structure that corresponds to the selected element, determining whether the selected element is an expected color, in response to determining the selected element is the expected color, setting a decoded color of the selected element the expected color, and in response to determining the selected element is not the expected color, decoding the color of the selected element.

Implementations can include one or more of the following features. For example, the coding line can be at least a portion of a row of the image. A first value can indicate the color of the selected element is the expected color and a second value can indicate the color of the selected element is not the expected color. The decoding of the color of the selected element can include looking-up an index value associated with the selected element in a color palette and setting the decoded color of the selected element based on the index value. The decoding of the color of the selected element can include identifying a row in the image as a reference line, determining an element in the reference line includes the color of the selected element. The determining that the element in the reference line includes the color of the selected element can include identifying a position of the determined element in the reference line and setting the color of the selected element based on the determined position. The position can be based on a relative position of the selected element in the decoding line and a position of the determined element in the reference line.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates a block diagram of a signal flow according to at least one example embodiment.

FIG. 2 illustrates a block diagram of elements according to at least one example embodiment.

FIG. 3A illustrates a block diagram of an encoder system according to at least one example embodiment.

FIG. 3B illustrates a block diagram of an encoder according to at least one example embodiment.

FIG. 4A illustrates a block diagram of a decoder system according to at least one example embodiment.

FIG. 4B illustrates a block diagram of a decoder according to at least one example embodiment.

FIG. 5A illustrates a block diagram of a method for encoding a color image according to at least one example embodiment.

FIG. 5B illustrates a block diagram of a method for encoding a color image according to at least one example embodiment.

FIG. 6A illustrates a block diagram of a method for decoding a color image according to at least one example embodiment.

FIG. 6B illustrates a block diagram of a method for decoding a color image according to at least one example embodiment.

FIG. 7 shows an example of a computer device and a mobile computer device according to at least one example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Compression algorithms can be used to compress images. These typical compression algorithms can result in a relatively large file size after image compression.

To achieve a higher compression rate, Group 4 compression can be used for some images that have characteristics that would make the images suitable for Group 4 compression. However, the images can have more than two (2) colors. Accordingly, Group 4 compression, which can be used to compress black and white images, can be adapted to compress these images that have more than two colors.

Example implementations described herein extend Group 4 compression to be used on images with more than two (2) colors. For example, a changing element can be defined as an element (e.g., a pixel) with a color different from that of the previous element in the same row of the image. In response to determining that an element is a changing element, an encoding event can be triggered. The encoding event can include assigning a color value (e.g., a three (3) byte value) to represent the color. Assigning the color value instead of just indicating a color change when an element (e.g., a pixel) color changes, can have the advantage of using the efficiency of the Group 4 compression technique on multi-color images and can result in relatively small compressed file sizes.

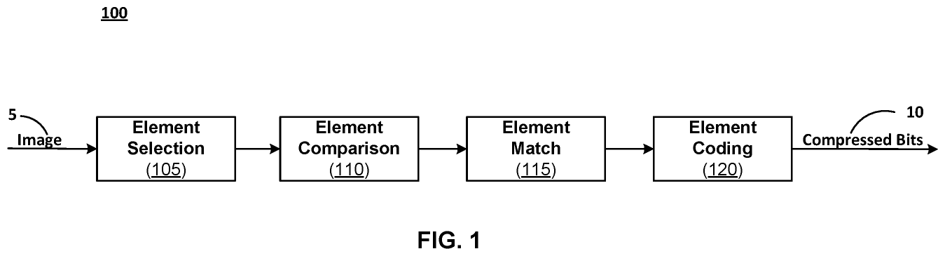

FIG. 1 illustrates a block diagram of a signal flow according to at least one example embodiment. As shown in FIG. 1, the signal flow 100 includes an element selection 105 block, an element comparison 110 block, an element match 115 block and an element coding 120 block. The signal flow 100 may be configured to receive an input image 5 (and/or a video stream) and output compressed (e.g., encoded) bits 10. In some implementations, the image 5 (or portions thereof) can include consecutive pixels (by row and/or by column) that have the same and/or similar colors. Group 4 compression can be an efficient (e.g., less processor usage, smaller memory use, and/or the like) compressing technique for images that include consecutive pixels (by row and/or by column) that have the same and/or similar colors.

The element selection 105 block can be configured to select an element (e.g., a pixel) to be compressed. In an example implementation, a compression order can be by row and pixel by pixel in the row. In other words, a row in the image can be selected for compression, then pixels are selected in a left to right (or right to left) order.

The element comparison 110 block can be configured to compare the color of a current (e.g., the selected (e.g., target, current) element to be compressed) element to the color of a previous (having been compressed) element. For example, the color of a second element in the row can be compared to the color of a first element in the row, the color of a third element in the row can be compared to the color of the second element in the row, the color of a fourth element in the row can be compared to the color of the third element in the row, and so forth. If the selected element to be compressed is the first element in the row, the color of the selected element can be compared to the color white.

The element match 115 block can be configured to identify an element (other than the previous element) having the same color as the selected element. The element match 115 block can be configured to identify an element in the same row, or a different row as the selected element. For example, the identified element can be in the row above (e.g., a row that has already been compressed), an element in the same row (excluding the previous element) that has been compressed and/or the like.

The element coding 120 block can be configured to encode the color of the selected element. In an example implementation, if the color of the selected element is the same color as the color of the previous element, encoding the selected element can include identifying (e.g., using a marker) the selected element as the same as the previous element (e.g., using a Boolean value (e.g., one (1) or zero (0))). If the color of the selected element is not the same color as the color of the previous element, encoding the selected element can include identifying the color. For example, an index value of a look-up table (e.g., a color palette) can be used to identify the color of the selected pixel or a reference value linking the color of the selected element to the matched element (from the element match 115 block) can be used to identify the color of the selected pixel. The index value can be used as an encoding value associated with the color. Other encoding techniques are described in more detail below.

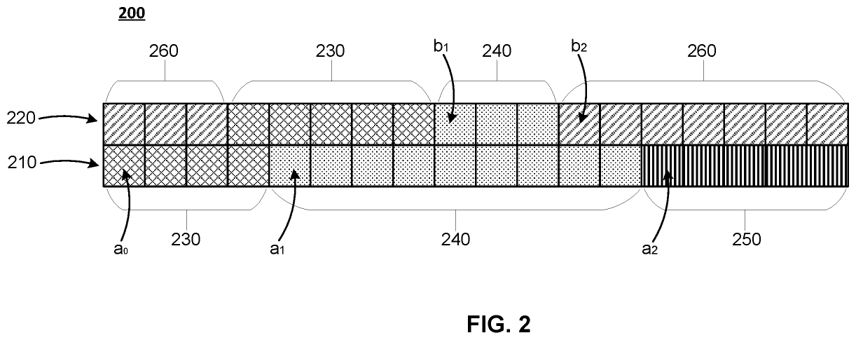

FIG. 2 illustrates a block diagram of elements according to at least one example embodiment. The elements can be pixels in an image (e.g., image 5). The block diagram 200 includes two rows and a plurality of columns. The bottom row can be a coding line 210 and the top row can be a reference line 220. The coding line 210 includes a plurality of elements (e.g., pixels) each having an associated color. The coding line 210 includes three (3) colors (shown as an example) of elements. The coding line 210 includes elements of a first color 230, elements of a second color 240 and elements of a third color 250.

The coding line 210 further includes three (3) identified elements. The identified elements can be changing elements. Identified element a₀ can be a reference or starting changing element on the coding line 210. A changing element can be an element (e.g., a pixel) whose color is different from that of the previous element in the same row of the image (e.g., image 5). At the start of the coding line 210 identified element a₀ can be set based on a white changing element situated just before (e.g., an element that does not exist) the first element on the coding line 210. During the coding of the coding line 210, the position of identified element a₀ can be defined by a coding mode (described below). Identified element a₁ can be the next changing element to the right of a₀ on the coding line 210. Identified element a₂ can be the next changing element to the right of a₁ on the coding line 210.

The reference line 220 includes a plurality of elements (e.g., pixels) each having an associated color. The reference line 220 includes three (3) colors (shown as an example) of elements. The reference line 220 includes elements of a fourth color 260 (in two groups of elements), elements of the first color 230, and elements of the second color 240.

The reference line 220 further includes two (2) identified elements. The identified elements can be changing elements. Identified element b₁ can be the first changing element on the reference line 220 to the right of identified element a₀ and of a different color from identified element a₀. Identified element b₂ can be the next changing element to the right of b₁ on the reference line 220. Alternatively, b₂ can be the next changing pixel to the right of b₁ on the reference line 220 whose color differs that of a₁.

The modified group 4 compression technique can include three (3) encoding modes. The encoding mode can be determined based on the position of a₁ in the coding line. In a first mode (sometimes called a pass mode), a₁ (the next changing pixel on the coding line 210) is in a column to the right of b₂ (the next changing element to the right of b₁) in the reference line 220. In the first mode, the next iteration of the algorithm sets a new position of a₀ (in the coding line 210) to the column of b₂ (of the reference line 220). The color of a₀ is unchanged. Therefore, there is no color change to signal. The process can repeat with the new position of a₀.

In a second mode (sometimes called a vertical mode), the column of a₁ (in the coding line 210) is within a number of elements (e.g., pixels) of b₁ (in the reference line 220). In the second mode, an offset can be encoded. The offset can be positive or negative. For example, the position of a₁ is the position of b₁ plus or minus the offset. The offset can be within a predetermined range (e.g., +/−3 elements). A Boolean value (e.g., 0 or 1) can be used to signal (e.g., using a marker) whether the color of a₁ is different from an expected color. The expected color can be defined as the color of b₁. If the color of b₁ is undefined, either because there is no previous row (the coding line 210 is the first row), or there is no element (e.g., pixel) on the reference line 220 to the right of a₀ whose color differs from that of a₀, the expected color can be set to any color different from that of a₀. For example, an algorithm common to the encoder and the decoder can be used.

In an example implementation, a color palette can be used. The expected color can be set, for example, to the first color of the color palette different from the color of a₀. If the color of a₁ is different from the expected color, the color of a₁ can be encoded based on an index in the color palette, a list of recent colors, the red, green and blue values of the new color, the delta between the red, green and blue values of the color and the previous color, and/or the like. A new position of a₀ (in the coding line 210) can be set to the position of a₁ (in the coding line 210). The process can repeat with the new position of a₀.

In a third mode (sometimes called a horizontal mode), a₁ can be located in a position (in the coding line 210) that does not meet the definition of the first mode or the second mode. In the third mode, the distance between a₀ and a₁ can be encoded as a value (e.g., an integer) in the range [1; distance(a₀, b₂)]. If the end (e.g., the last column) of the encoding line 210 hasn't been reached, the distance between a₁ and a₂ can be encoded as a value (e.g., an integer) in the range [1; distance(a₁, end_of_line)].

In addition, in the third mode, the color of a₁ can be signaled using the same technique described above with regard to the second mode. A Boolean value (e.g., 0 or 1) can be used to signal (e.g., using a marker) whether the color of a₁ is different from an expected color. The expected color can be defined as the color of b₁. If the color of b₁ is undefined, either because there is no previous row (the coding line 210 is the first row), or there is no pixel on the reference line 220 to the right of a₀ whose color differs from that of a₀, the expected color can be set to any color different from that of a₀. For example, an algorithm common to the encoder and the decoder can be used. In an example implementation, a color palette can be used. The expected color can be set, for example, to the first color of the palette different from the color of a₀. If the color of a₁ is different from the expected color, the color of a₁ can be encoded based on an index in a palette, a list of recent colors, the red, green and blue values of the new color, the delta between the red, green and blue values of the color and the previous color, and/or the like.

The color of a₂ can be similarly encoded. A Boolean value (e.g., 0 or 1) can be used to signal (e.g., using a marker) whether the color of a₂ is different from an expected color. The expected color can be defined as the color of b₂. If the color of b₂ is undefined, either because there is no previous row (the coding line 210 is the first row), or there is no element (e.g., pixel) on the reference line 220 to the right of b₁ whose color differs from that of a₁, the expected color can be set to any color different from that of a₁. In an example implementation, the expected color can be set to the color of a₀, the next color to the right of b₂, and/or the like. If the color of a₂ is different from the expected color, the actual color of a₂ can be encoded. A new position of a₀ (in the coding line 210) can be set to the position of a₂ (in the coding line 210). The process can repeat with the new position of a₀. In all three modes, if the end of the coding line 210 has been reached, encoding can proceed with the next row.

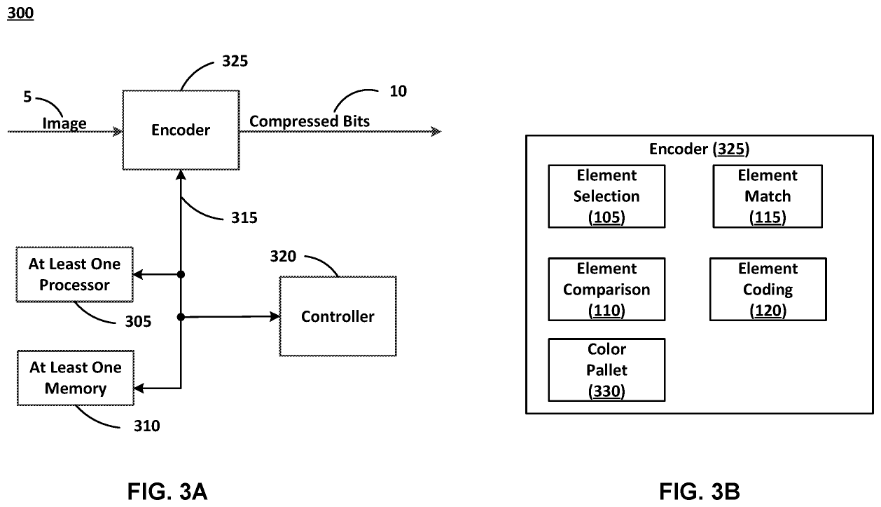

FIG. 3A illustrates the encoder system according to at least one example embodiment. As shown in FIG. 3A, the encoder system 300 includes the at least one processor 305, the at least one memory 310, a controller 320, and an encoder 325. The at least one processor 305, the at least one memory 310, the controller 320, and the encoder 325 are communicatively coupled via bus 315.

In the example of FIG. 3A, an encoder system 300 may be, or include, at least one computing device and should be understood to represent virtually any computing device configured to perform the techniques described herein. As such, the encoder system 300 may be understood to include various components which may be utilized to implement the techniques described herein, or different or future versions thereof. By way of example, the encoder system 300 is illustrated as including at least one processor 305, as well as at least one memory 310 (e.g., a non-transitory computer readable storage medium).

The at least one processor 305 may be utilized to execute instructions stored on the at least one memory 310. Therefore, the at least one processor 305 can implement the various features and functions described herein, or additional or alternative features and functions. The at least one processor 305 and the at least one memory 310 may be utilized for various other purposes. For example, the at least one memory 310 may represent an example of various types of memory and related hardware and software which may be used to implement any one of the modules described herein.

The at least one memory 310 may be configured to store data and/or information associated with the encoder system 300. The at least one memory 310 may be a shared resource. For example, the encoder system 300 may be an element of a larger system (e.g., a server, a personal computer, a mobile device, and/or the like). Therefore, the at least one memory 310 may be configured to store data and/or information associated with other elements (e.g., image/video serving, web browsing or wired/wireless communication) within the larger system.

The controller 320 may be configured to generate various control signals and communicate the control signals to various blocks in the encoder system 300. The controller 320 may be configured to generate the control signals to implement the techniques described herein. The controller 320 may be configured to control the encoder 325 to encode an image, a sequence of images, a video frame, a sequence of video frames, and/or the like according to example implementations. For example, the controller 320 may generate control signals corresponding to selecting an encoding mode.

The encoder 325 may be configured to receive an input image 5 (and/or a video stream) and output compressed (e.g., encoded) bits 10. The encoder 325 may convert a video input into discrete video frames (e.g., as images). The input image 5 may be compressed (e.g., encoded) as compressed image bits. The encoder 325 may further convert each image (or discrete video frame) into a C×R matrix of blocks or macro-blocks (hereinafter referred to as blocks). For example, an image may be converted to a 32×32, a 32×16, a 16×16, a 16×8, an 8×8, a 4×8, a 4×4 or a 2×2 matrix of blocks each having a number of pixels. Although eight (8) example matrices are listed, example implementations are not limited thereto.

Further, the encoder 325 may use the modified Group 4 technique to encode at least one block of the C×R matrix of blocks. In other words, the encoder may not use a same encoding technique for an entire image (e.g., image 5). Therefore, the modified Group 4 technique can be used to encode the image and/or a portion of the image (e.g., a block, a plurality of blocks, and/or the like). In an example implementation, the modified Group 4 technique can be used to encode each block of the C×R matrix of blocks, and a portion of the encoded blocks can be selected to be included in a compressed file representing the image. The portion can be selected based on compression performance, results, file size and/or the like.

The compressed bits 10 may represent the output of the encoder system 300. For example, the compressed bits 10 may represent an encoded image (or video frame). For example, the compressed bits 10 may be stored in a memory (e.g., at least one memory 310). For example, the compressed bits 10 may be ready for transmission to a receiving device (not shown). For example, the compressed bits 10 may be transmitted to a system transceiver (not shown) for transmission to the receiving device.

The at least one processor 305 may be configured to execute computer instructions associated with the controller 320 and/or the encoder 325. The at least one processor 305 may be a shared resource. For example, the encoder system 300 may be an element of a larger system (e.g., a mobile device, a server, and/or the like). Therefore, the at least one processor 305 may be configured to execute computer instructions associated with other elements (e.g., image/video serving, web browsing or wired/wireless communication) within the larger system.

FIG. 3B illustrates a block diagram of the encoder 325 according to at least one example embodiment. As shown in FIG. 3B, the encoder 325 can include the element selection 105 block, the element comparison 110 block, the element match 115 block, the element coding 120 block, and a color palette 330 block. The color palette 330 can be used by the element coding 120 block during the selection of a color (e.g., an index number) associated with encoding an element. In other words, the index number can be an encoding value corresponding to the color.

The color palette 330 can include a plurality of indexed colors. The colors can be channel based (e.g., red, green and blue individually) or color combination based (e.g., red, green and blue together). For example, the color palette 330 can be a look-up table with n (e.g., 8, 16, 32, 256, 512) rows with each row indexed to a color combination. For example, the color palette 330 can be a look-up table for each color (e.g., red, green, blue) with n (e.g., 8, 16, 32, 256, 512) rows with each row indexed to an individual color value (e.g., a value with a range of 0-255).

The color palette 330 can be a preset (e.g., colors and/or color combinations) before encoding. The color palette 330 can be generated for each image (e.g., image 5). For example, on a first occurrence of a color for an element (e.g., a changing element), the color can be added to the color palette 330 and indexed sequentially (e.g., a next number in integer order). The color palette can be sorted based on color occurrence frequency (e.g., the more often a color is seen, the earlier the color is in the look-up table). The color palette 330 can be color (e.g., three (3) channels or three (3) dimensional) and/or grayscale (e.g., single channel or one (1) dimensional).

In an example implementation, the element comparison 110 block can determine that the element (e.g., pixel) is a changing element (e.g., a different color than the previously encoded element). In response to determine that the element is a changing element, the element coding 120 block can search for the color (e.g., combination of colors, each individual color (three channel), individual color (one channel)) in the color palette 330 and determine an index value (e.g., at least one integer value) for the color. The index value can be used to represent the color in a compressed image data structure. In other words, the index value can be used as an encoding value corresponding to the color of the element.

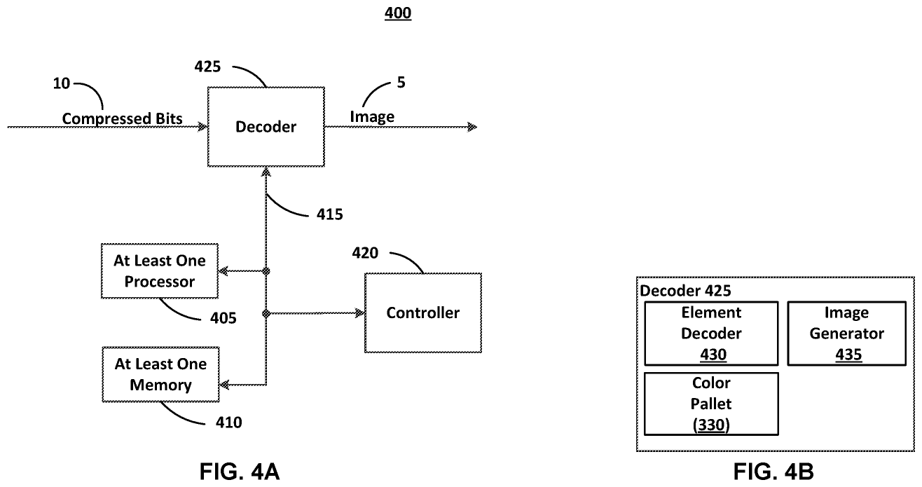

FIG. 4A illustrates a block diagram of a decoder system according to at least one example embodiment. As shown in FIG. 4A, the decoder system 400 includes the at least one processor 405, the at least one memory 410, a controller 420, and a decoder 425. The at least one processor 405, the at least one memory 410, the controller 420, and the decoder 425 are communicatively coupled via bus 415.

In the example of FIG. 4A, a decoder system 400 may be at least one computing device and should be understood to represent virtually any computing device configured to perform the techniques described herein. As such, the decoder system 400 may be understood to include various components which may be utilized to implement the techniques described herein, or different or future versions thereof. For example, the decoder system 400 is illustrated as including at least one processor 405, as well as at least one memory 410 (e.g., a computer readable storage medium).

Therefore, the at least one processor 405 may be utilized to execute instructions stored on the at least one memory 410. As such, the at least one processor 405 can implement the various features and functions described herein, or additional or alternative features and functions. The at least one processor 405 and the at least one memory 410 may be utilized for various other purposes. For example, the at least one memory 410 may be understood to represent an example of various types of memory and related hardware and software which can be used to implement any one of the modules described herein. According to example implementations, the encoder system 300 and the decoder system 400 may be included in a same larger system (e.g., a personal computer, a mobile device and the like).

The at least one memory 410 may be configured to store data and/or information associated with the decoder system 400. The at least one memory 410 may be a shared resource. For example, the decoder system 400 may be an element of a larger system (e.g., a personal computer, a mobile device, and the like). Therefore, the at least one memory 410 may be configured to store data and/or information associated with other elements (e.g., web browsing or wireless communication) within the larger system.

The controller 420 may be configured to generate various control signals and communicate the control signals to various blocks in the decoder system 400. The controller 420 may be configured to generate the control signals in order to implement the video encoding/decoding techniques described herein. The controller 420 may be configured to control the decoder 425 to decode a video frame according to example implementations.

The decoder 425 may be configured to receive compressed (e.g., encoded) bits 10 as input and output an image 5. The compressed (e.g., encoded) bits 10 may also represent compressed video bits (e.g., a video frame). Therefore, the decoder 425 may convert discrete video frames of the compressed bits 10 into a video stream. The decoder 425 can be configured to decompress (e.g., decode) an image that was compressed using a modified Group 4 compression technique. Therefore, the decoder 425 can be configured to implement a modified Group 4 decompression technique. In other words, the decoder 425 can be a modified Group 4 decoder.

The at least one processor 405 may be configured to execute computer instructions associated with the controller 420 and/or the decoder 425. The at least one processor 405 may be a shared resource. For example, the decoder system 400 may be an element of a larger system (e.g., a personal computer, a mobile device, and the like). Therefore, the at least one processor 405 may be configured to execute computer instructions associated with other elements (e.g., web browsing or wireless communication) within the larger system.

According to an example implementation, a portion of data structure (e.g., compressed bits 10) generated using the modified Group 4 compression technique may be n, 1, x₁, n where a 1 indicates a change, an x identifies the changed element color, and a n indicates a number of elements at the same color. Therefore, the modified Group 4 decompression technique can be configured to determine a color associated with x₁.

FIG. 4B illustrates a block diagram of the decoder 425 according to at least one example embodiment. Decoder 425 can be a modified Group 4 decoder. As shown in FIG. 4B, the decoder 425 includes an element decoder 430 block, an image generator 435 block, and the color palette 330 block. The element decoder 430 can be configured to determine whether a compressed image element is the same color as a previous element (e.g., a Boolean 0 from the above example) or a different color as the previous element (e.g., a Boolean 1 from the example above).

In response to the element decoder 430 determining the color is the same color, the element decoder 430 communicates color information representing the same color to the image generator 435. In response to the element decoder 430 determining the color is not the same color, the element decoder 430 looks-up the color in the color palette using, for example an index value and communicates color information representing the color returned from the look-up operation to the image generator 435.

The image generator 435 can be configured to generate an image based on the color information received from the element decoder 430. For example, the image generator 436 can insert a color value (e.g., red, green and blue) into a data structure based on an element position (e.g., row and column) representing an image. The image generator 435 can output the generated image as image 5 (e.g., reconstructed image 5).

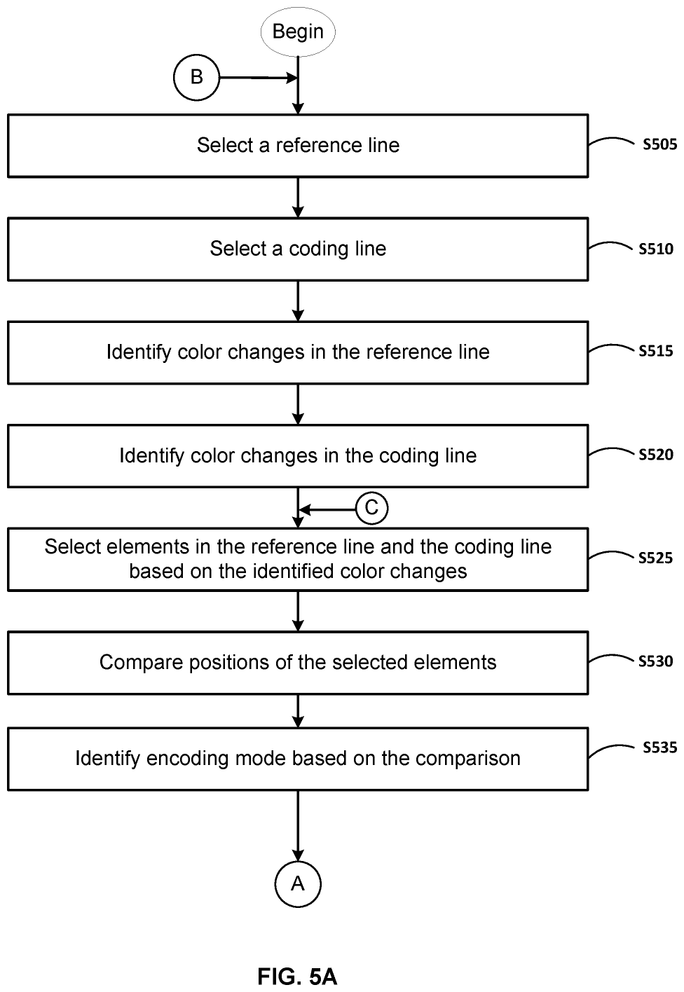

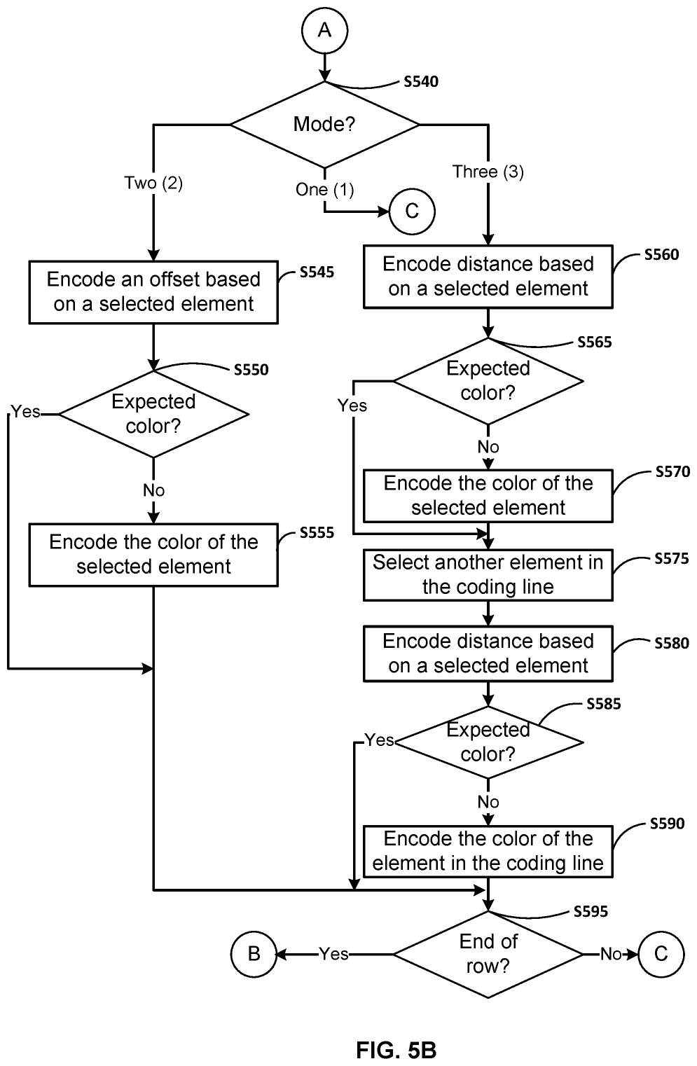

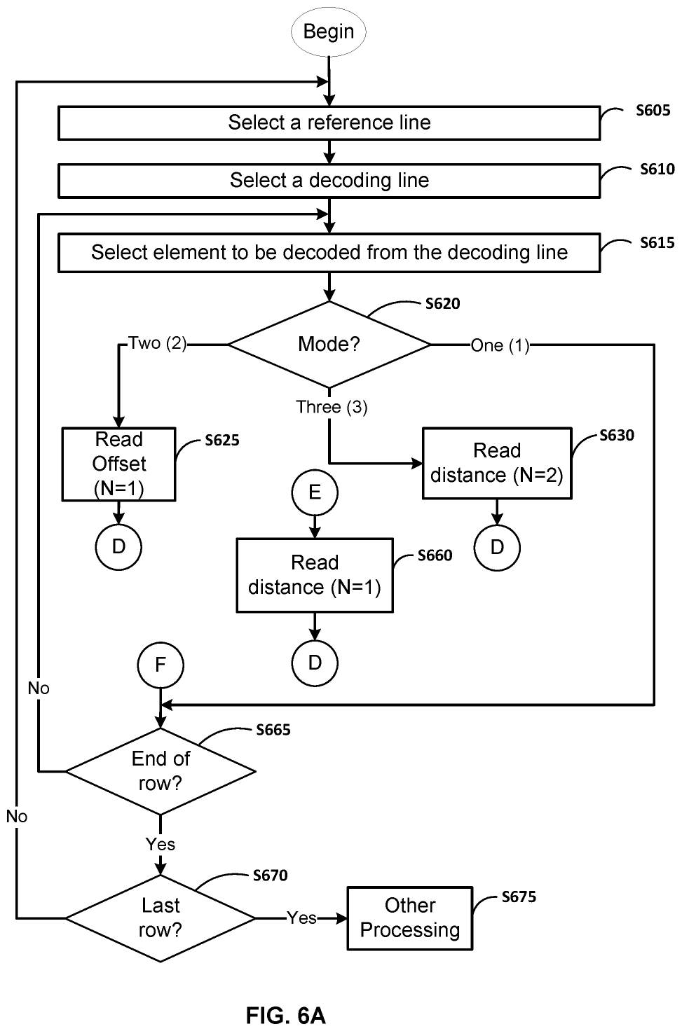

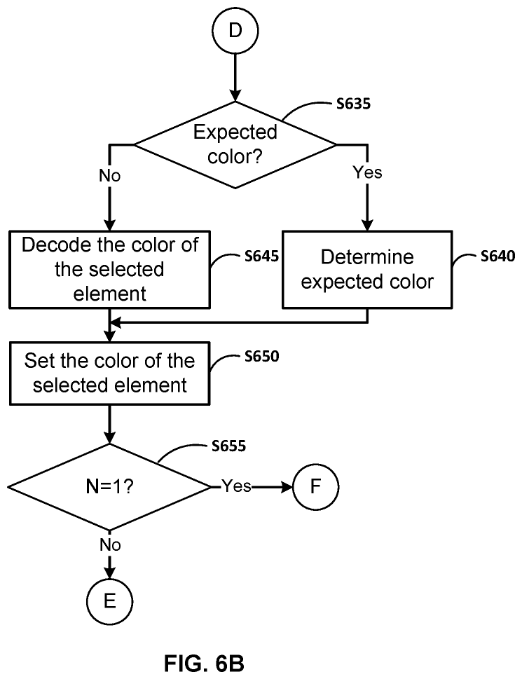

FIGS. 5A, 5B, 6A, and 6B illustrate block diagrams of methods according to at least one example embodiment. The steps described with regard to FIGS. 5A, 5B, 6A, and 6B may be performed due to the execution of software code stored in a memory (e.g., at least one memory 310, 410) associated with an apparatus (e.g., as shown in FIGS. 3A and 4A) and executed by at least one processor (e.g., at least one processor 305, 405) associated with the apparatus. However, alternative embodiments are contemplated such as a system embodied as a special purpose processor. Although the steps described below are described as being executed by a processor, the steps are not necessarily executed by the same processor. In other words, at least one processor may execute the steps described below with regard to FIGS. 5A, 5B, 6A, and 6B.

FIG. 5A illustrates a block diagram of a method for encoding a color image according to at least one example embodiment. The method for encoding a color image can be triggered in response to receiving an image (e.g., image 5) including a plurality of color elements (e.g., pixels) to compress (e.g., encode) the image. As shown in FIG. 5A, in step S505 a reference line is selected. For example, an image (e.g., image 5) can include a plurality of rows (R) and a plurality of columns (C). The reference line can be one of the rows (R). Alternatively, or in addition to, the image can be broken into a C×R matrix of blocks or macro-blocks (referred to as blocks). The reference line can be at least one row (R) in the matrix of blocks.

In step S510 a coding line is selected. For example, an image (e.g., image 5) can include a plurality of rows (R) and a plurality of columns (C). The coding line can be one of the rows (R). Alternatively, or in addition to, the image can be broken into a C×R matrix of blocks or macro-blocks (referred to as blocks). The coding line can be at least one row (R) in the matrix of blocks. In an example implementation, the coding line is below the reference line (see FIG. 2). In the case of the coding line being the first row in an image or block, the reference line can be a row of elements (e.g., pixels) having a default color (e.g., white).

In step S515 color changes in the reference line are identified. For example, each color change (from (or not including) the first color in the reference line) can be determined. Referring to FIG. 2, b₁ and b₂ can be located. Noting that more than two (2) color changes can be found and that b₁ and b₂ nomenclature can be based on coding row color changes (e.g., a₁). Locating color changes can included stepping (via software code) through each element (e.g., pixel) in the reference line and comparing the color of an element to the color of the previous element. In response to determining the color is different, the element is identified as a changing element (e.g., b₁ and b₂ of FIG. 2).

In step S520 color changes in the coding line are identified. For example, each color change (including the first color in the coding line) can be determined. Referring to FIGS. 2, a₀, a₁ and a₂ can be located. Noting that more than three (3) color changes can be found. Locating color changes can include stepping (via software code) through each element (e.g., pixel) in the coding line and comparing the color of an element to the color of the previous element. In response to determining the color is different, the element is identified as a changing element (e.g., a₀, a₁ and a₂ of FIG. 2).

In step S525 elements in the reference line and the coding line are selected based on the identified color changes. The identified elements can be changing elements. The identified elements can be changing elements used in an encoding algorithm iteration. For example, the selected element can be the first element (e.g., a₀ in FIG. 2), a second coding line element (e.g., a₁ in FIG. 2), a third coding line element (e.g., a₂ in FIG. 2), a first reference line element (e.g., b₁ in FIG. 2), and a second reference line element (e.g., b₂ in FIG. 2).

In step S530 the positions of the selected elements are compared. For example, the position (e.g., column) of a₁ in the coding line 210 can be compared to the position (e.g., column) of b₂ in the reference line 220. For example, the position (e.g., column) of a₁ in the coding line 210 can be compared to the position (e.g., column) of b₁ in the reference line 220. The result of the comparison can be used to identify (or determine) an encoding (e.g., one (1) of three (3)) modes).

In step S535 an encoding mode is identified based on the comparison(s). For example, if the position (e.g., column) of a₁ in the coding line 210 is the right of the position (e.g., column) of b₂ in the reference line 220, the encoding mode can be a first (e.g., pass) encoding mode. If the position (e.g., column) of a₁ in the coding line 210 is proximate (e.g., within a number of columns or a range of columns) to the position (e.g., column) of b₁ in the reference line 220, the encoding mode can be a second (e.g., vertical) encoding mode. Otherwise, the encoding mode can be a third (e.g., horizontal) encoding mode.

In a first mode, there is no color change. In the first mode (sometimes called a pass mode), a₁ (the next changing pixel on the coding line 210) is in a column to the right of b₂ (the next changing element to the right of b₁) in the reference line 220. In the first mode, the next iteration of the algorithm sets a new position of a₀ (in the coding line 210) to the column of b₂ (of the reference line 220). The color of a₀ is unchanged. Therefore, there is no color change to signal. The process can repeat with the new position of a₀.

In a second mode (sometimes called a vertical mode), the column of a₁ (in the coding line 210) is within a number of elements (e.g., pixels) of b₁ (in the reference line 220). In the second mode, an offset and a color can be encoded. In the second mode, a Boolean value (e.g., 1 or 0) can be set to signal (e.g., using a marker) the color is different and the encoding event can encode the color of the element (e.g., a pixel) as, for example, an index in a color palette, in a list of most recently used colors, a channel (e.g., RGB) value, a channel delta (e.g., as compared to a previously encoded element), and/or the like.

In a third mode (sometimes called a horizontal mode), a₁ can be located in a position (in the coding line 210) that does not meet the definition of the first mode or the second mode. In the third mode, in addition to encoding the element (as in the first mode), the color of a₂ is different from the color of b₂. In response to determining the color of a₂ is different from the color of b₂, a Boolean value (e.g., 1 or 0) can be set to signal (e.g., using a marker) the color is different and the color of a₂ can be encoded (e.g., as in the first mode.

FIG. 5B illustrates a block diagram of a method for encoding a color image according to at least one example embodiment. As shown in FIG. 5B, in step S545, in a second mode (step S540), an offset based on a selected element is encoded. In the second mode (sometimes called a vertical mode), the column of a₁ (in the coding line 210) is within a number of elements (e.g., pixels) of b₁ (in the reference line 220). The offset can be positive or negative. For example, the position of a₁ is the position of b₁ plus or minus the offset. The offset can be within a predetermined range (e.g., +/−3 elements).

In step S550 whether or not the color of the selected element is an expected color is determined. For example, in an example implementation the elements can be pixels. Each pixel can have a corresponding color (e.g., three (3) channels or three (3) dimensional) red, green and blue and/or grayscale (e.g., single channel or one (1) dimensional) a gradient color ranging from black to white. Comparing the colors (e.g., the color of the selected element to the expected color) can include determining the color of elements and comparing the determined colors.

A Boolean value (e.g., 0 or 1) can be used to signal (e.g., using a marker) whether the color of a₁ is different from an expected color. In an example implementation, the expected color can be defined as the color of b₁. If the color of b₁ is undefined, either because there is no previous row (the coding line 210 is the first row), or there is no element (e.g., pixel) on the reference line 220 to the right of a₀ whose color differs from that of a₀, the expected color can be set to any color different from that of a₀. In an alternative implementation, the color of the selected element can be compared to the element before (e.g., directly to the left of) the selected element. If the color of the selected element is not the expected color, processing continues to step S555. If the color of the selected element is the expected color, a Boolean value indicating the color is as expected (e.g., a Boolean 0) can be inserted (e.g., as a marker) in the encoding data structure and processing continues to step S595.

In step S555 the color of the selected element is encoded. For example, an algorithm common to the encoder and the decoder can be used. For example, the color can be encoded (e.g., as an encoding value) as an index value selected from a color palette (e.g., color palette 330).

The color palette (e.g., color palette 330) can include a plurality of indexed colors. The colors can be channel based (e.g., red, green and blue individually) or color combination based (e.g., red, green and blue together). For example, the color palette can be a look-up table with n (e.g., 8, 16, 32, 256, 512) rows with each row indexed to a color combination. For example, the color palette can be a look-up table for each color (e.g., red, green, blue) with n (e.g., 8, 16, 32, 256, 512) rows with each row indexed to an individual color value (e.g., a value with a range of 0-255).

The color palette can be a preset (e.g., colors and/or color combinations) before encoding. The color palette can be generated for each image (e.g., image 5). For example, on a first occurrence of a color for an element (e.g., a changing element), the color can be added to the color palette and indexed sequentially (e.g., a next number in integer order). The color palette can be sorted based on color occurrence frequency (e.g., the more often a color is seen, the earlier the color is in the look-up table). The color palette can be color (e.g., three (3) channels or three (3) dimensional) and/or grayscale (e.g., single channel or one (1) dimensional).

The determined color of the selected palette can be searched for (e.g., a look-up process, a filter process, and/or the like) in the color palette. If the determined color of the selected element is located, the index number of the located color can be returned and used to encode the element. In an example implementation, if the determined color of the selected element is not located, the determined color can be added to the color palette and assigned a new index number. The new index number of the added color can be returned and used to encode the element. In this implementation, the color palette can be stored with the compressed image (e.g., in a header as metadata).

In an example implementation, whether the reference line includes an element having the same color as the selected element (in the coding line) is determined. If the reference line includes an element having the same color, the color of the selected element can be encoded based on the element in the reference line. For example, the same index number of the color palette as the element in the reference line can be used in the encoding. For example, a relative position (e.g., the same column (C), number of columns to the left, number of columns to the right, and/or the like) of the element in the reference line (as compared to the selected element) can be used in the encoding.

In an example implementation, whether the coding line includes a previously encoded element having the same color as the selected element is determined. If the coding line includes an element having the same color, the color of the selected element can be encoded based on the element in the coding line. For example, the same index number of the color palette as the element in the coding line can be used in the encoding. For example, a relative position (e.g., number of columns (C) to the left) of the element in the coding line (as compared to the selected element) can be used in the encoding.

In an example implementation, whether the selected element has a color that is somewhat the same as the previous element can be determined. For example, whether red has changed, green has changed, or blue has changed, and the other colors remain the same in the selected element as the previous element. If the selected element has a color that is somewhat the same as the previous element, the color of the selected element can be encoded based on the color similarity. For example, the value of the color (e.g., 0 to 255), an integer difference (e.g., +/−n), and/or the like can be used in the encoding.

In step S560, in the third mode (step S540), an distance based on a selected element is encoded. In the third mode (sometimes called a horizontal mode), a₁ can be located in a position (in the coding line 210) that does not meet the definition of the first mode or the second mode. In the third mode, the distance between a₀ and a₁ can be encoded as the distance (e.g., an integer) in the range [1; distance (a₀, b₂)]. If the end (e.g., the last column) of the encoding line 210 hasn't been reached, the distance between a₁ and a₂ can be encoded as the distance (e.g., an integer) in the range [1; distance(a₁, end_of_line)].

In step S565 whether or not the color of the selected element is an expected color is determined. For example, in an example implementation the elements can be pixels. Each pixel can have a corresponding color (e.g., three (3) channels or three (3) dimensional) red, green and blue and/or grayscale (e.g., single channel or one (1) dimensional) a gradient color ranging from black to white. Comparing the colors (e.g., the color of the selected element to the expected color) can include determining the color of elements and comparing the determined colors.

A Boolean value (e.g., 0 or 1) can be used to signal (e.g., using a marker) whether the color of a₁ is different from an expected color. In an example implementation, the expected color can be defined as the color of b₁. If the color of b₁ is undefined, either because there is no previous row (the coding line 210 is the first row), or there is no pixel on the reference line 220 to the right of a₀ whose color differs from that of a₀, the expected color can be set to any color different from that of a₀. If the color of the selected element is not the expected color, processing continues to step S570. If the color of the selected element is the expected color, a Boolean value (e.g., as a marker) indicating the color is as expected (e.g., a Boolean 0) can be inserted (e.g., as a marker) in the encoding data structure and processing continues to step S575.

In step S570, in a third mode (step S540), the color of the selected element is encoded. As in step S555, the color of the selected element can be encoded as an index value selected from a color palette (e.g., color palette 330), encoded based on the color of an element in the reference line and/or encoded based on the color of an element in the coding line.

In step S575 another element in the coding line is selected. For example, the next changing element (e.g., a₂ in FIG. 2) can be selected, the element before (e.g., to the left of) the next changing element (e.g., a₂ in FIG. 2) can be selected, and/or the last element in the row (R) can be selected.

In step S580, in the third mode (step S540), an distance based on a selected element is encoded. In the third mode (sometimes called a horizontal mode), a₁ can be located in a position (in the coding line 210) that does not meet the definition of the first mode or the second mode. In the third mode, the distance between a₀ and a₁ can be encoded as the distance (e.g., an integer) in the range [1; distance (a₀, b₂)]. If the end (e.g., the last column) of the encoding line 210 hasn't been reached, the distance between a₁ and a₂ can be encoded as the distance (e.g., an integer) in the range [1; distance(a₁, end_of_line)].

In step S585 whether or not the color of the other element is an expected color is determined. For example, in an example implementation the elements can be pixels. Each pixel can have a corresponding color (e.g., three (3) channels or three (3) dimensional) red, green and blue and/or grayscale (e.g., single channel or one (1) dimensional) a gradient color ranging from black to white. Comparing the colors (e.g., the color of the selected element to the expected color) can include determining the color of elements and comparing the determined colors.

A Boolean value (e.g., 0 or 1) can be used to signal (e.g., using a marker) whether the color of the other is different from an expected color. The expected color can be defined as the color of b₂. If the color of b₂ is undefined, either because there is no previous row (the coding line 210 is the first row), or there is no element (e.g., pixel) on the reference line 220 to the right of b₁ whose color differs from that of a₁, the expected color can be set to any color different from that of a₁. In an example implementation, the expected color can be set to the color of a₀, the next color to the right of b₂, and/or the like. If the color of a₂ is different from the expected color, the actual color of a₂ can be encoded.

If the color is not as expected (step S585), the other element is encoded (step S590) as described above. For example, the other element can be encoded based on an index value of the color palette (e.g., color palette 330). If the color is as expected (step S585), processing continues to step S595.

In step S595 whether the selected element (or the selected another element) is the last element in the row (e.g., in the coding line) is determined. For example, a row can include a marker indicating the last element, a row length (or position) counter can be used, and/or the like. If the selected element is the last element in the row, processing continues to step S505. Otherwise, processing continues to step S525. A test for end of image file can also be included which can cause the compression of the image (e.g., image 5) to complete.

In an example implementation, the encoding of the Boolean and/or color (e.g., color palette index) can be done using entropy coding with probabilities encoded in the compressed data structure (or bitstream). In an example implementation, the encoding of the changing element (the Boolean, color, and/or color palette index) can be omitted (e.g., not inserted into the data structure) if the end of the row has been reached.

FIG. 6A illustrates a block diagram of a method for decoding a color image according to at least one example embodiment. The method for decoding a color image can be triggered in response to receiving a file including a data structure representing a compressed image (e.g., compressed bits 10) including a plurality of color elements (e.g., pixels) to generate (e.g., decompress, encode) a reconstructed image (e.g., image 5). As shown in FIG. 6A, in step S605 a reference line is selected. For example, an image (e.g., image 5) can include a plurality of rows (R) and a plurality of columns (C). During a decoding process, the image can be a size C×R of elements having a default color (e.g., white). The size of the image can be based on the size of the compressed image. The reference line can be one of the rows (R). Alternatively, or in addition to, the image can be broken into a C×R matrix of blocks or macro-blocks (referred to as blocks). The reference line can be at least one row (R) in the matrix of blocks.

In step S610 a decoding line is selected. For example, an image (e.g., image 5) can include a plurality of rows (R) and a plurality of columns (C). The decoding line can be one of the rows (R). Alternatively, or in addition to, the image can be broken into a C×R matrix of blocks or macro-blocks (referred to as blocks). The decoding line can be at least one row (R) in the matrix of blocks. In an example implementation, the coding line is below the reference line (see FIG. 2). In the case of the coding line being the first row in an image or block, the reference line can be a row of elements (e.g., pixels) having a default color (e.g., white).

In step S615 an element to be decoded is selected from the decoding line. For example, the first element, second element, third element, . . . , can be selected in some order from left to right. The selected element can be the first element (e.g., in a row in the image (or block) initially and then subsequent elements in order. In an example implementation, the mode (e.g., mode one (1), mode two (2), mode three (3), and/or the like) can determine the order sequence. For example, in mode one, the next element can be the next sequential element. However, in mode two and/or mode three the next element can be two or more elements after the current element. Selecting the element can include identifying the corresponding element in the data structure.

In step S620 a mode for decoding the element is determined. For example, the mode for decoding the element can be the mode that the element was encoded using. The data structure representing the compressed image can include a value indicating the mode used to encode the element. For example, in a first mode (sometimes called a pass mode) there is no color change. In a second mode (sometimes called a vertical mode) and a third mode (sometimes called a horizontal mode) there can be a color change (as compared to a previous element). If the mode is determined to be the first mode, processing continues to step S665 and no color needs to be decoded. If the mode is determined to be the second mode, processing continues to step S625 which begins a color decoding process. If the mode is determined to be the third mode, processing continues to step S630 which begins a color decoding process.

In step S625 an offset is read and a counter (N) is set to one (1) because the color of one (1) element is to be decoded. For example, the offset can be positive or negative. For example, referring to FIG. 2, the position of a₁ is the position of b₁ plus or minus the offset. The offset can be within a predetermined range (e.g., +/−3 elements). The offset can be read from the data structure representing the compressed image. The offset can be used to determine the color of the element using the reverse algorithm as used in the encoder. Processing continues to step S635 (see FIG. 6B).

In step S630 a distance is read and a counter (N) is set to two (2) because the color of two (2) elements are to be decoded. For example, referring to FIG. 2, the distance between a₀ and a₁ can be encoded as a value (e.g., an integer) in the range [1; distance (a₀, b₂)]. If the end (e.g., the last column) of the encoding line 210 hasn't been reached, the distance between a₁ and a₂ can be encoded as a value (e.g., an integer) in the range [1; distance(a₁, end_of_line)]. The distance can be read from the data structure representing the compressed image. The distance can be used to determine the color of the element using the reverse algorithm as used in the encoder. Processing continues to step S635 (see FIG. 6B).

Referring to FIG. 6B, in step S635 whether the selected element is an expected color is determined. For example, the compressed image data structure can include a Boolean value (e.g., 0) indicating (e.g., as a marker) the color was the expected color during the encoding process or a Boolean value (e.g., 1) indicating (e.g., as a marker) the color was not the expected color during the encoding process. If the selected element is the expected color, processing continues to step S640. Otherwise, if the selected element is not the expected color, processing continues to step S645.

In step S640 an expected color is determined. For example, the expected color can be the color of an element that has previously been decoded (e.g., an element in the reference line. The element can be the element in the reference line in the column to the left or right based on the offset (e.g., reference line column C+/− offset) of the selected element. The color of the element in the reference line can be read as the color of the selected element.

In step S645 the color of the selected element is decoded. For example, the encoded value can be an index value of a color in a color palette (e.g., color palette 330). Therefore, the color can be decoded by looking-up the color in the color palette using the index value. For example, the encoded value can be associated with an element in the reference line. Therefore, the color can be decoded by determining (e.g., in the same column, a different column, and/or the like) which element in the reference line that the selected element is associated with and using the color of the decoded element in the reference line. For example, the encoded value can be associated with a previously decoded element in the decoding line. Therefore, the color can be decoded by determining (e.g., the column in the decoding line) which element in the decoding line that the selected element is associated with and using the color of the decoded element in the decoding line.

In step S650 the color of the selected element is set. For example, the color of the selected element can be set as one of the decoded color (S645) or the expected color (S640). In step S655 whether or not N=1 is determined. For example, in mode two (2) one color may be decoded and in mode three (3) two colors may be decoded. Therefore, in step S625 (mode two (2)) N is set to equal one (N=1), in step S630 (mode three (3) first color being decoded) N is set to equal two (N=2), in step S660 (mode three (3) second color being decoded) N is set to equal one (N=1). If N=1, processing continues to step S665. Otherwise, if N=2, processing continues to step S660.

In step S660 a distance is read and a counter (N) is set to one (1) because the color of one (1) element is to be decoded (the first color in the third mode having been decoded). For example, referring to FIG. 2, the distance between a₀ and a₁ can be encoded as a value (e.g., an integer) in the range [1; distance (a₀, b₂)]. If the end (e.g., the last column) of the encoding line 210 hasn't been reached, the distance between a₁ and a₂ can be encoded as a value (e.g., an integer) in the range [1; distance(a₁, end_of_line)]. The distance can be read from the data structure representing the compressed image. The distance can be used to determine the color of the element using the reverse algorithm as used in the encoder. Processing continues to step S635 (see FIG. 6B).

In step S665 if the selected element is the last element in the decoding line, processing continues to step S670. For example, a row can include a marker indicating the last element, a row length (or position) counter can be used, and/or the like. If the selected element is the last element in the row, processing continues to step S645. Otherwise, the element is not the last element and processing returns to step S610.

In step S670 if the decoding line is the last row in the image, processing continues to step S675 where some other processing can be performed (e.g., additional processing in the image pipeline (e.g., error correction)). For example, a row can include a marker indicating the last element in the file and/or the file may not include any additional data. Otherwise, if the decoding line is not the last row in the image, processing returns to step S605.

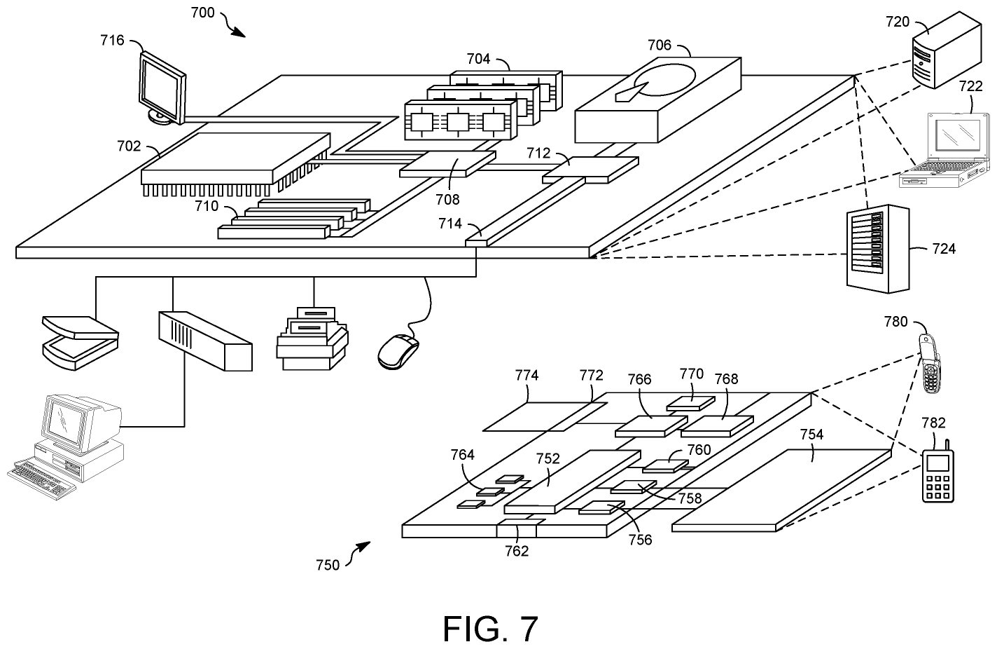

FIG. 7 shows an example of a computer device 700 and a mobile computer device 750, which may be used with the techniques described here. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smart phones, and other similar computing devices. The components shown here, their connections and relationships, and their functions, are me1,0,0ant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smart phone 782, personal digital assistant, or other similar mobile device.

Implementations can include a device, a system, a non-transitory computer-readable medium (having stored thereon computer executable program code which can be executed on a computer system), and/or a method can perform a process with a method including receiving an image targeted for compression into a compressed image, identifying a coding line including a plurality of elements, each of the plurality of elements having a color, selecting an element from the plurality of elements from the coding line in the image, determining a presented color associated with the selected element, comparing the presented color to an expected color, and in response to determining the presented color is not the expected color inserting a marker into a data structure representing a portion of the compressed image, the marker indicating that the presented color is not the expected color, determining an encoding value corresponding to the presented color, and inserting the encoding value into the data structure representing the compressed image.

Implementations can include one or more of the following features. For example, the marker can be a Boolean. The coding line can be at least a portion of a row of the image. The selected element can represent a pixel of at least three (3) colors. Determining the encoding value corresponding to the presented color can include looking-up the presented color in a color palette and setting the encoding value as an index value of the color palette that is associated with the presented color. Determining the encoding value corresponding to the presented color can include determining the presented color is not in a color palette, inserting the presented color into the color palette, generating an index value for the inserted presented color, and setting the encoding value as the generated index value. Determining the encoding value corresponding to the presented color can include identifying a row in the image as a reference line, the reference line including a plurality of encoded elements, determining that one of the plurality of encoded elements in the reference line includes the expected color, and in response to determining that one of the plurality of encoded elements in the reference line includes the expected color, setting the encoding value based on one of the plurality of encoded elements.

Setting the encoding value based on one of the plurality of encoded elements can include identifying the encoding value of one of the plurality of encoded elements, and setting the encoding value as the encoding value of one of the plurality of encoded elements. Setting the encoding value based on the determined element can include identifying a position of one of the plurality of encoded elements in the reference line and setting the encoding value based on the identified position. Setting the encoding value based on the identified position can include setting the encoding value as a relative value based on a position of the selected element in the coding line and the position of the identified element in the reference line. The method can further include selecting another element from the plurality of elements from the coding line in the image, determining whether the selected another element is the last element in the encoding line and in response to determining the selected another element is the last element in the encoding line, not inserting at least one of the marker and the encoding value into the data structure representing a portion of the compressed image.

Implementations can include a device, a system, a non-transitory computer-readable medium (having stored thereon computer executable program code which can be executed on a computer system), and/or a method can perform a process with a method including receiving a data structure representing an image to be decompressed, the image including a plurality of color elements, selecting an element to be decoded from a decoding line in the image, identifying an element in the data structure that corresponds to the selected element, determining whether the selected element is an expected color, in response to determining the selected element is the expected color, setting a decoded color of the selected element the expected color, and in response to determining the selected element is not the expected color, decoding the color of the selected element.

Implementations can include one or more of the following features. For example, the coding line can be at least a portion of a row of the image. A first value can indicate the color of the selected element is the expected color and a second value can indicate the color of the selected element is not the expected color. The decoding of the color of the selected element can include looking-up an index value associated with the selected element in a color palette and setting the decoded color of the selected element based on the index value. The decoding of the color of the selected element can include identifying a row in the image as a reference line, determining an element in the reference line includes the color of the selected element. The determining that the element in the reference line includes the color of the selected element can include identifying a position of the determined element in the reference line and setting the color of the selected element based on the determined position. The position can be based on a relative position of the selected element in the decoding line and a position of the determined element in the reference line.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor (e.g., a processor formed on a silicon substrate, a GaAs substrate, and the like) or some other programmable data processing apparatus.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

1. A method comprising:
receiving an image targeted for compression into a compressed image;
identifying a coding line including a plurality of elements, each of the plurality of elements having a color;
selecting an element from the plurality of elements from the coding line in the image;
determining a presented color associated with the selected element;
comparing the presented color to an expected color; and
in response to determining the presented color is not the expected color:
inserting a marker into a data structure representing a portion of the compressed image, the marker indicating that the presented color is not the expected color,
determining an encoding value corresponding to the presented color, and
inserting the encoding value into the data structure representing the compressed image.

2. (canceled)

3. The method of claim 1, wherein the coding line is at least a portion of a row of the image.

4. (canceled)

5. The method of claim 1, wherein determining the encoding value corresponding to the presented color includes:
looking-up the presented color in a color palette, and setting the encoding value as an index value of the color palette that is associated with the presented color.

6. The method of claim 1, wherein determining the encoding value corresponding to the presented color includes:
determining the presented color is not in a color palette,
inserting the presented color into the color palette,
generating an index value for the inserted presented color, and
setting the encoding value as the generated index value.

7. The method of claim 1, wherein determining the encoding value corresponding to the presented color includes:
identifying a row in the image as a reference line, the reference line including a plurality of encoded elements,
determining that one of the plurality of encoded elements in the reference line includes the expected color, and
in response to determining that one of the plurality of encoded elements in the reference line includes the expected color, setting the encoding value based on one of the plurality of encoded elements.

8. The method of claim 7, wherein setting the encoding value based on one of the plurality of encoded elements includes:
identifying the encoding value of one of the plurality of encoded elements, and
setting the encoding value as the encoding value of one of the plurality of encoded elements.

9. The method of claim 8, wherein setting the encoding value based on the determined element includes:
identifying a position of one of the plurality of encoded elements in the reference line, and
setting the encoding value based on the identified position.

10. The method of claim 9, wherein setting the encoding value based on the identified position includes:
setting the encoding value as a relative value based on a position of the selected element in the coding line and the position of the identified element in the reference line.

11. The method of claim 1, further comprising:
selecting another element from the plurality of elements from the coding line in the image;
determining whether the selected another element is the last element in the encoding line; and
in response to determining the selected another element is the last element in the encoding line, not inserting at least one of the marker and the encoding value into the data structure representing a portion of the compressed image.

12. A non-transitory computer-readable storage medium having stored thereon computer executable program code which, when executed on a computer system, causes the computer system to perform a method comprising:
receiving an image and targeted for compression into a compressed image;
identifying a coding line including a plurality of elements, each of the plurality of elements having a color;
selecting an element from the plurality of elements from the coding line in the image;
determining a presented color associated with the selected element;
comparing the color to an expected color;
in response to determining the presented color is not the expected color:
inserting a marker into a data structure representing a portion of the compressed image, the marker indicating that the presented color is not the expected color,
determining an encoding value corresponding to the presented color, and
inserting the encoding value into the data structure representing a portion of the compressed image.

13. (canceled)

14. The non-transitory computer-readable storage medium of claim 12, wherein the coding line is at least a portion of the image.

15. (canceled)

16. The non-transitory computer-readable storage medium of claim 12, wherein the determining of the encoding value corresponding to the presented color includes:
looking-up the presented color in a color palette, and
setting the encoding value as an index value of the color palette that is associated with the presented color.

17. The non-transitory computer-readable storage medium of claim 12, wherein the determining of the encoding value corresponding to the presented color includes:
determining the presented color is not in a color palette,
inserting the presented color into the color palette,
generating an index value for the inserted presented color, and
setting the encoding value as the generated index value.

18. The non-transitory computer-readable storage medium of claim 12, wherein the determining of the encoding value corresponding to the presented color includes:
identifying a row in the image as a reference line, the reference line including a plurality of encoded elements,
determining that one of the plurality of encoded elements in the reference line includes the presented color, and
in response to determining one of the encoded elements in the reference line includes the expected color, setting the encoding value based on one of the encoded elements.

19. The non-transitory computer-readable storage medium of claim 18, wherein setting the encoding value based on one of the encoded elements includes:
identifying the encoding value of one of the encoded elements, and
setting the encoding value as the encoding value of one of the encoded elements.

20. The non-transitory computer-readable storage medium of claim 18, wherein setting the encoding value based on one of the encoded elements includes:
identifying a position of one the encoded elements in the reference line, and
setting the encoding value based on the identified position.

21. The non-transitory computer-readable storage medium of claim 20, wherein setting the encoding value based on the identified position includes:
setting the encoding value as a relative value based on a position of the selected element in the coding line and the position of the element in the reference line.

22. The non-transitory computer-readable storage medium of claim 12, the method further comprising:
determining whether the selected element is the last element in the encoding line, and
in response to determining the selected element is the last element in the encoding line, not inserting at least one of marker and the encoding value into the data structure representing a portion of the compressed image.

23. A method comprising:
receiving a data structure representing an image to be decompressed;
identifying a decoding line including a plurality of elements, each of the plurality of elements having a color;
selecting an element to be decoded from the plurality of elements from the decoding line in the image;
identifying an element in the data structure that corresponds to the selected element;
determining whether the selected element is an expected color;
in response to determining the selected element is the expected color, setting a decoded color of the selected element as the expected color; and
in response to determining the selected element is not the expected color, decoding the selected element.

24. The method of claim 23, wherein the decoding line is at least a portion of a row of the image.

25. The method of claim 23, wherein a first marker value indicates the color of the selected element is the expected color and a second marker value indicates the color of the selected element is not the expected color.

26. The method of claim 23, wherein the decoding of the presented color of the selected element includes:
looking-up an index value associated with the selected element in a color palette, and
setting the decoded color of the selected element based on the index value.

27. The method of claim 23, wherein the decoding of the presented color of the selected element includes:
identifying a row in the image as a reference line, and
determining an element in the reference line includes the presented color of the selected element.

28. The method of claim 27, wherein the determining that the element in the reference line includes the presented color of the selected element includes:
identifying a position of the determined element in the reference line, and
setting the presented color of the selected element based on the determined position.

29. The method of claim 28, wherein the position is based on a relative position of the selected element in the decoding line and a position of the determined element in the reference line.

30-32. (canceled)
